(19) United States
(12) Patent Application Publication
(10) Pub. No.: US 2012/0151234 A1
(43) Pub. Date: Jun. 14, 2012

(54) METHOD AND APPARATUS FOR MESSAGE HANDLING DURING POWER SAVING MODES

(75) Inventors: Edward H. Teague, San Diego, CA (US); David J. Walker, San Diego, CA (US)

(73) Assignee: QUALCOMM Incorporated, San Diego, CA (US)

(21) Appl. No.: 12/969,780

(22) Filed: Dec. 16, 2010

Related U.S. Application Data
(60) Provisional application No. 61/420,898, filed on Dec. 8, 2010.

(51) Int. Cl. G06F 1/32

(52) U.S. Cl. 713/323

(57) ABSTRACT

A method for implementing a sleep control that includes the steps of receiving a message from a sending block via a messaging bus, wherein the message is destined for a receiving block; determining whether the receiving block is awake; and delaying further transmission of the message until the receiving block is awake. An apparatus for performing the method is also disclosed.

### CLAIM OF PRIORITY UNDER 35 U.S.C. §119

The present application for patent claims priority to Provisional Application No. 61/420,898, entitled “Method and Apparatus for Message Handling During Power Saving Modes” filed Dec. 8, 2010, the contents of which are assigned to the assignee hereof and hereby expressly incorporated by reference herein.

### BACKGROUND

I. Field

The following description relates generally to integrated circuits, and more particularly to method and apparatus for message handling during power saving modes.

II. Background

Many electronic devices, such as mobile phones and portable computers, are battery operated and many measures are often taken to reduce their power consumption. One approach used to reduce power consumption is shutting down components in the electronic devices that are not currently in use. The component that is shut down generally disables its clock and waits for a signal instructing it to wake up, i.e., to enter an active mode. In certain applications, a portion of the component may need to be active even as the majority of the component is shut down.

In another approach, where a processor with multiple internal modules coupled to a bus is in a power saving mode and certain parts of the processor is put to sleep and while other parts need to remain awake. When one module of the processor needs to send data to a sleeping module, it needs to enable the sleeping module and then wait for the sleeping module to be awoken before transmitting the data. Another approach is a system with modules that wake up responsive to transmissions from a master unit, each unit waking up only for specific transmissions directed to it. The master unit has to control the waking/sleeping of each module.

The waking up process may take time, referred to as a “wake up latency.” In some cases, if the source of transmitted data is not aware that the receiving unit is asleep and the wake up latency is not sufficiently short, the sleeping unit will wake up only after at least part of the data from the source was transmitted and the transmission will be lost.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to systems and/or methods that provide sleep control messaging, where a method for implementing a sleep control for a multi-block chip system includes receiving a message from a sending block via a messaging bus, wherein the message is destined for a receiving block; determining whether the receiving block is awake; and delaying further transmission of the message until the receiving block is awake.

In another aspect, an apparatus for sleep control includes a bus interface coupled to a bus and configured to receive a message from a sending block via the bus interface; and a block interface coupled to a block and configured to determine whether the block is awake; wherein the bus interface requests delay of a further transmission of the message until the block is awake.

In yet another aspect, an apparatus for sleep control is provided that includes means for receiving a message from a sending block via a messaging bus, wherein the message is destined for a receiving block; means for determining whether the receiving block is awake; and means for delaying further transmission of the message until the receiving block is awake.

In yet another aspect, a computer-program product for sleep control is provided that includes a machine-readable medium comprising instructions executable to receive a message from a sending block via a messaging bus, wherein the message is destined for a receiving block; determine whether the receiving block is awake; and delay further transmission of the message until the receiving block is awake.

In yet another aspect, a medical device is provided that includes a sensor; a bus interface coupled to a bus and configured to receive a message from on the sensor via the bus; and a block interface coupled to a block and configured to determine whether the block is awake; wherein the bus interface requests delay of a further transmission of the message until the block is awake.

In yet another aspect, a gaming controller is provided that includes an antenna, a bus interface coupled to the antenna and a bus and configured to receive a message from the antenna via the bus; and a block interface coupled to a block and configured to determine whether the block is awake; wherein the bus interface requests delay of a further transmission of the message until the block is awake.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a block diagram of a wireless communication apparatus as configured in accordance with an aspect of the disclosure in which the power saving system disclosed herein may be used;

FIG. 2 is a flow diagram of a message handling process for an interface of a block that is contained in an integrated circuit and that is sleeping, configured in accordance with one aspect of the disclosure that may be used in the wireless communication apparatus of FIG. 1;

FIG. 3 is a block diagram illustrating the message handling process of FIG. 2 configured in accordance with an aspect of the disclosure; and

FIG. 4 is a block diagram illustrating the functionality of an apparatus for a message handling process during sleep mode in accordance with one aspect of the disclosure.

### DETAILED DESCRIPTION

Various aspects of the novel systems, apparatus and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that that the scope of disclosure is intended to cover any aspect of the novel systems, apparatus and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

The various aspects of the disclosure are directed to a sleep control architecture for an integrated circuit (IC) with multiple blocks coupled to a communications bus, each block having the capability to sleep independently to conserve power used by the IC. Each block has an interface that couples the block to the bus. The interface allows communication with the bus and remains awake even when its respective block is in sleep mode. When a message is received by an interface from a sending block, the interface will determine if its respective block is awake. If not, then the interface will wake the block while requesting the bus to pause transmission from the sending block. The interface will request the bus pause transmission by stalling the sending block. In one aspect of the request, the interface and bus communicate using a Simple Messaging Protocol (SMP). The disclosed architecture allows blocks to transmit messages to each other without having to determine if a respective receiving block is asleep. Thus, a sender will simply transmit a message and not have to include additional complexities for dealing with a receiver being in sleep mode.

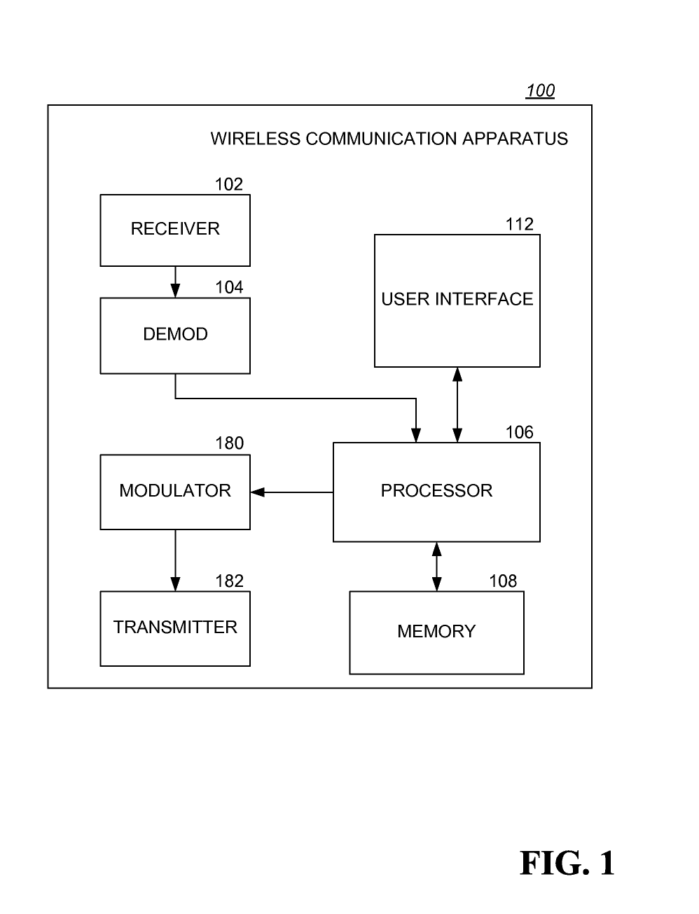

FIG. 1 is an illustration of a wireless communication apparatus 100, in which the IC including the sleep control architecture may be included. One or more of the modules described herein may be implemented with the IC having the sleep control architecture. It should be noted that the example of the device provided herein is only an example of how the IC having the sleep control architecture may be used. The wireless communication apparatus 100 includes a receiver 102 that receives a signal from, for instance, a receive antenna (not shown), performs typical actions on (e.g., filters, amplifies, downconverts, etc.) the received signal, and digitizes the conditioned signal to obtain samples. Receiver 102 then passes the samples to a demodulator 104 that can demodulate received symbols and provide them to a processor 106 for data processing. The processor 106 can be a processor dedicated to analyzing information received by the receiver 102 and/or generating information for transmission by a transmitter 182, a processor that controls one or more components of the wireless communication apparatus 100, and/or a processor that both analyzes information received by the receiver 102, generates information for transmission by the transmitter 182, and controls one or more components of the wireless communication apparatus 100.

The wireless communication apparatus 100 can further comprise a user interface 112 coupled to the processor 106 that allows the wireless communication apparatus 100 to operate with multiple sectors in accordance with one aspect of the disclosure. The wireless communication apparatus 100 still further comprises a modulator 180 and transmitter 182 that respectively modulate and transmit signals to, for instance, another wireless communication apparatus (access terminals, access points, etc.). This can operate as part of a disparate bidirectional wireless network utilized to communicate information. Although depicted as being separate from the processor 106, it is to be appreciated that the multi-sector communication unit 112, demodulator 104, and/or modulator 180 can be part of the processor 106 or multiple processors (not shown).

The wireless communication apparatus 100 can additionally comprise a memory 108 that is operatively coupled to the processor 106 and that can store data to be transmitted, received data, information related to available channels, data associated with analyzed signal and/or interference strength, information related to an assigned channel, power, rate, or the like, and any other suitable information for estimating a channel and communicating via the channel. The memory 108 can additionally store protocols and/or algorithms associated with estimating and/or utilizing a channel (e.g., performance based, capacity based, etc.) as well as operating with multiples sectors.

It will be appreciated that the data store (e.g., the memory 108) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 108 of the subject apparatus and methods is intended to comprise, without being limited to, these and any other suitable types of memory.

It should be noted that the teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a monitor that may receive data from the medical or environment sensing device, a computer, a point-of-sale device, an entertainment device, a hearing aid, a set-top box, or any other suitable device. The teachings herein may also be incorporated into a variety of gaming devices. For example, remote controls for gaming consoles such as gaming controllers used with Wii™, PlayStation™ or Xbox 360™ or other gaming platforms, as well as gaming controllers used with personal computers, including tablets, computing pads, laptops or desktops. Any of the devices described herein may be implemented using some or all parts of the components described in FIG. 1.

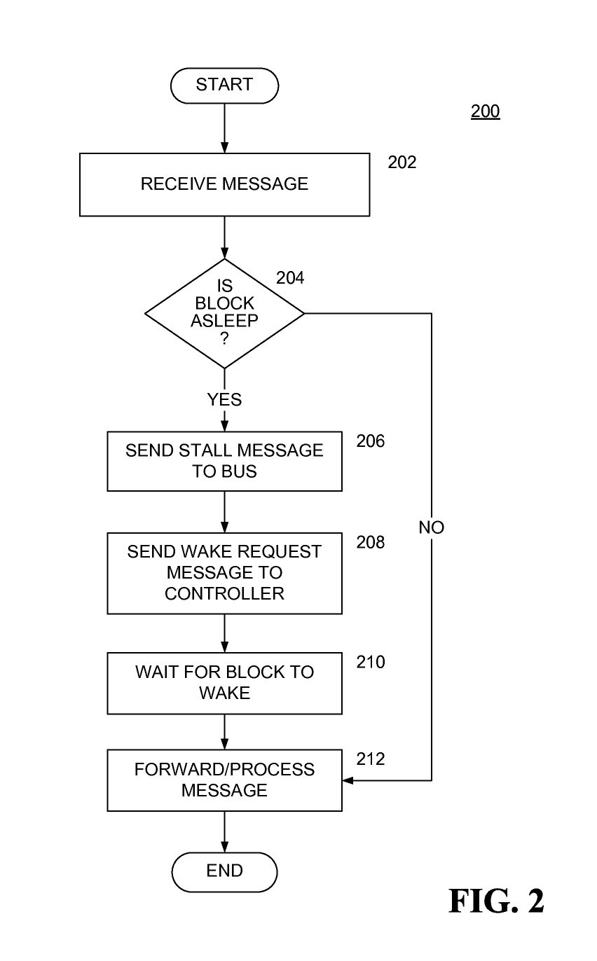

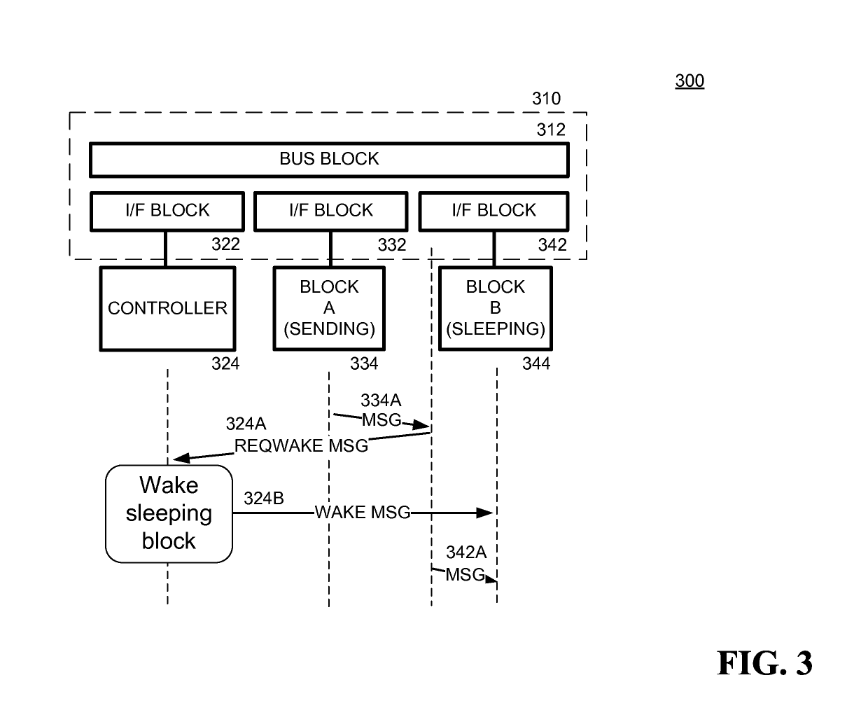

FIG. 2 illustrates a message handling process 200 for an interface of a sleeping device. The message handling process 200 will be described while further referring to FIG. 3, where a first block A 334 wants to send a second block B 344 a message (MSG) 334A. The controller 324 is used to control the sleep mode of the first block A 334, and the second block B 344. The controller 324, the first block A 334, and the second block B 344 are coupled for communication to a communication interface 410 that includes a bus 312. Each of the blocks are coupled to the bus 312 through respective I/F blocks 322, 332 and 342. It should be noted that a block may be implemented in hardware, software, firmware, or a combination thereof. By way of example and not limitation, the block may represent the modules discussed in FIG. 1.

The controller 324 manages sleep of one or more blocks and is able to receive messages related to sleep for the blocks. Multiple blocks, grouped into block groups, may also be controlled by the controller 324. In the former case, the controller 324 communicates directly with each block. In the latter implementation, the controller 324 may also communicate with block group masters. The controller 324 may communicate with individual blocks or block group masters in preparing for and waking from sleep, and manages clock gate and power switch to blocks or block groups. Specifically, this includes the switching of the provision of power and clock signals.

In the following example, an ARM block (or, an ARM), which is represented by the first block A 334, sends a message destined for a MAC block (or, a MAC), which is represented by the second block B 344, via an SMP switch, which is represented by the bus 312. As described above, the MAC block is in a sleep state. However, as noted above, the MAC block includes an interface (or, a MAC SMP interface), which is represented by the I/F block 342, that is coupled to the bus. It should be noted that the ARM can send the message to the SMP switch without worrying about whether MAC block is asleep. The SMP switch routes the message to the interface for the MAC (the MAC SMP interface) based on the address contained in the first part of the message that arrives. At this point, the MAC SMP interface, if the MAC is awake, will forward the message to the MAC. Otherwise, if the MAC is asleep, the MAC SMP interface stalls out further transmission of the message—i.e., stops the sending block from sending further messages. Also, once the MAC SMP interface determines that the MAC is asleep, it will send a message to the controller to request the controller wake the MAC. The SMP interface determines that the MAC is awake and so will allow the transmission of the rest of the signal.

In step 202, the I/F block 342 for the block B 344 starts receiving the transmission of the MSG 334A. In one aspect of the receiving process, the I/F block 342 will receive the initial portion of the MSG 334A and immediately proceed to the next step.

In step 204, the I/F block 342 will determine if the block B 344 is in a sleep mode. If so, then operations will continue with step 206. Otherwise, if the block B 344 is in a sleep mode, then operations will continue with step 210.

In step 206, if the I/F block 342 determines that the block B 344 is in sleep mode, the I/F block 342 will send a stall message to the bus 312. The stall message will prevent the block A 334 from further transmitting the MSG 334A. Operation will then continue with step 208.

In step 208, the I/F block 342 will send a wake request message (REQWAKE MSG) 424A to the controller 324 to request that the controller 324 wake the block B 344. When the controller 324 receives the request, it will wake the block B 344 with a wake message (WAKE MSG) 324B. The wake message 324B will include an indicator to the block B 344 to inform the block that it has been asleep. This will allow the block B 344 to know that it is not initializing and therefore not perform any unnecessary operations related to it.

In step 210, the I/F block 342 will wait for the block B 344 to awake before moving onto the next step. Since all messages to the block B 344 will be stalled until the block B 344 is awake, no further message processing is necessary until the block is awake.

In step 212, the message may be forwarded to and processed by the block B 344 after the block B 344 completes the wake process. In one aspect of the operation of the system, the controller 324 will inform the block B 344 as part of the wake message that it was previously in a sleep mode so that the block B 344 can perform other operations to reinitialize itself.

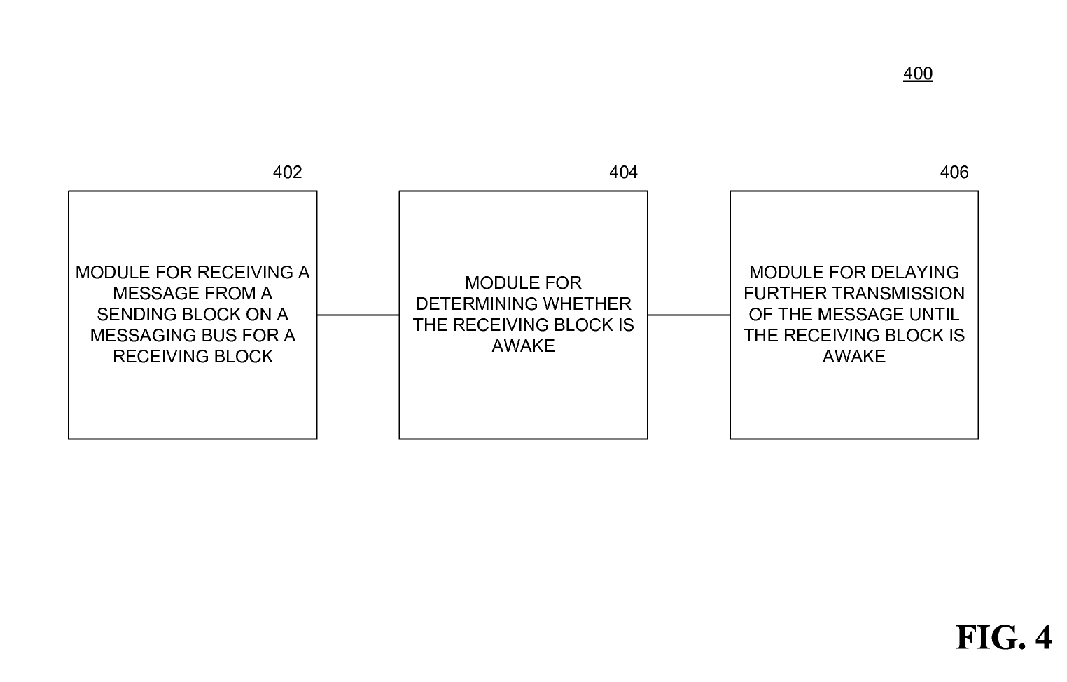

FIG. 4 is a diagram illustrating the functionality of an apparatus 400 in accordance with one aspect of the disclosure. The apparatus 400 includes a module 402 for receiving a message from a sending block on a messaging bus for a receiving block; a module 404 for determining whether the receiving block is awake; and a module 406 for delaying further transmission of the message until the receiving block is awake.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The previous description is provided to enable any person skilled in the art to fully understand the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for implementing a sleep control, comprising:
receiving a message from a sending block via a messaging bus, wherein the message is destined for a receiving block;
determining whether the receiving block is awake; and
delaying further transmission of the message until the receiving block is awake.

2. The method of claim 1, further comprising
waking the receiving block; and
completing transmission of the message to the receiving block.

3. The method of claim 2, wherein waking the receiving block further comprises sending a request to a sleep controller to wake the receiving block.

4. The method of claim 3, wherein the sleep controller transmits a wake message to the receiving block.

5. The method of claim 1, wherein delaying further transmission of the message comprises:
receiving a first portion of the message; and
requesting the sending block to pause transmission.

6. The method of claim 5, wherein the first portion of the message comprises a word.

7. The method of claim 1, wherein receiving the message from the sending block further comprises buffering at least a portion of the message.

8. An apparatus for sleep control comprising:
a bus interface coupled to a bus and configured to receive a message from a sending block via the bus interface; and
a block interface coupled to a block and configured to determine whether the block is awake;
wherein the bus interface requests delay of a further transmission of the message until the block is awake.

9. The apparatus of claim 8, wherein the block interface is further configured to wake the block and the bus interface is configured to request completion of the transmission of the message to the block.

10. The apparatus of claim 9, wherein the block interface is further configured to send a request to a sleep controller to wake the block.

11. The apparatus of claim 10, wherein the sleep controller transmits a wake message to the block.

12. The apparatus of claim 8, wherein the request to delay the further transmission of the message comprises:
receiving a first portion of the message; and
requesting the sending block to pause transmission.

13. The apparatus of claim 12, wherein the first portion of the message comprises a word.

14. The apparatus of claim 8, wherein the receipt of the message from the sending block further comprises buffering at least a portion of the message.

15. An apparatus for wireless communications comprising:
means for receiving a message from a sending block via a messaging bus, wherein the message is destined for a receiving block;
means for determining whether the receiving block is awake; and
means for delaying further transmission of the message until the receiving block is awake.

16. A computer-program product for communication, comprising:
a machine-readable medium comprising instructions executable to:
receive a message from a sending block via a messaging bus, wherein the message is destined for a receiving block;
determine whether the receiving block is awake; and
delay further transmission of the message until the receiving block is awake.

17. A medical device, comprising:
a sensor;
a bus interface coupled to the sensor and a bus and configured to receive a message from the sensor via the bus; and
a block interface coupled to a block and configured to determine whether the block is awake;
wherein the bus interface requests delay of a further transmission of the message until the block is awake.

18. A gaming controller, comprising:
an antenna;
a bus interface coupled to the antenna and a bus and configured to receive a message from the antenna via the bus; and
a block interface coupled to a block and configured to determine whether the block is awake;
wherein the bus interface requests delay of a further transmission of the message until the block is awake.
